(19) United States
(12) Patent Application Publication
(10) Pub. No.: US 2025/0102806 A1
(43) Pub. Date: Mar. 27, 2025

(54) VIRTUAL IMAGE DISPLAY DEVICE AND OPTICAL UNIT

(71) Applicant: SEIKO EPSON CORPORATION, Tokyo (JP)

(72) Inventor: Masayuki TAKAGI, Azumino-shi (JP)

(73) Assignee: SEIKO EPSON CORPORATION, Tokyo (JP)

(21) Appl. No.: 18/895,765

(22) Filed: Sep. 25, 2024

(30) Foreign Application Priority Data
Sep. 26, 2023 (JP) 2023-162915

(51) Int. Cl. G02B 27/01; F21V 8/00; G02B 27/00

(52) U.S. Cl. CPC G02B 27/0172; G02B 6/003; G02B 27/0081; G02B 2027/0114

(57) ABSTRACT

A display panel that emits an image light beam, a projection optical system that collimates the image light beam from the display panel, and a light-guiding member including a light-guiding plate that guides the image light beam, an incidence portion that causes the image light beam to enter the light-guiding plate, a relay portion that guides the image light beam passing through the incidence portion and enlarges a pupil in a first direction, and an emission portion that guides the image light beam passing through the relay portion, and emits the image light beam from the light-guiding plate are provided, an exit pupil of the projection optical system has a shape in which a vertical width is larger than a lateral width, and the incidence portion has a shape in which a vertical width is larger than a lateral width, correspondingly to the shape of the exit pupil.

The present application is based on, and claims priority from JP Application Serial Number 2023-162915, filed Sep. 26, 2023, the disclosure of which is hereby incorporated by reference herein in its entirety.

### BACKGROUND

### 1. Technical Field

The present disclosure relates to a virtual image display device and an optical unit that enable observation of a virtual image.

### 2. Related Art

There is a display device that enables observation of a virtual image, the display device including a light-guiding member on which an image light beam emitted from an image light generation device is incident, a first diffraction element being provided on an incidence side of the light-guiding member, a second diffraction element being provided on an emission side of the light-guiding member, and a mirror being provided at an end portion of the light-guiding member on the incidence side (JP 2021-156995 A). In the device disclosed in JP 2021-156995 A, an image light beam passing through the first diffraction element is reflected by the mirror and propagates through the light-guiding member, and the image light beam passing through the second diffraction element is emitted toward an eye.

In the display device disclosed in JP 2021-156995 A, when a size of the image light generation device is reduced in order to reduce a size of the device, there is a risk that brightness efficiency is reduced.

### SUMMARY

A virtual image display device or an optical unit in an aspect of the present disclosure includes a display panel configured to emit an image light beam, a projection optical system configured to collimate the image light beam from the display panel, and a light-guiding member including a light-guiding plate that guides the image light beam, an incidence portion that causes the image light beam to enter the light-guiding plate, a relay portion that guides the image light beam passing through the incidence portion and enlarges a pupil in a first direction, and an emission portion that guides the image light beam passing through the relay portion, enlarges the pupil in a second direction orthogonal to the first direction, and emits the image light beam from the light-guiding plate, wherein an exit pupil of the projection optical system has a shape in which a vertical width is larger than a lateral width, and the incidence portion has a shape in which a vertical width is larger than a lateral width, correspondingly to the shape of the exit pupil.

### BRIEF DESCRIPTION OF THE DRAWINGS

FIG. 1 is a plan view for describing a mounted state of an HMD being a first embodiment.

FIG. 2 is a side view for describing an arrangement or the like of an optical system constituting a virtual image display device.

FIG. 3 is a plan view for describing the arrangement or the like of the optical system constituting the virtual image display device.

FIG. 4 is a front view for describing a light-guiding optical system or a light-guiding member.

FIG. 5 is a conceptual plan view for describing an optical system of a first display driving unit.

FIG. 6 is a conceptual side view for describing the optical system of the first display driving unit.

FIG. 7 is a conceptual perspective view for describing the optical system of the first display driving unit.

FIG. 8 is a plan view for describing a display surface of a display panel.

FIG. 9 is a conceptual view for describing an angle characteristic and the like of the first display driving unit.

FIG. 10 is an optical path view for describing a modification of the optical system of the first display driving unit.

FIG. 11 is a conceptual plan view for describing an optical system in a second embodiment.

FIG. 12 is a conceptual side view for describing the optical system in the second embodiment.

FIG. 13 is a diagram for describing an example and a comparative example of the optical system of the second embodiment.

FIG. 14 is an optical path view illustrating an example of light beams in the optical system of the second embodiment.

### DESCRIPTION OF EMBODIMENTS

### First Embodiment

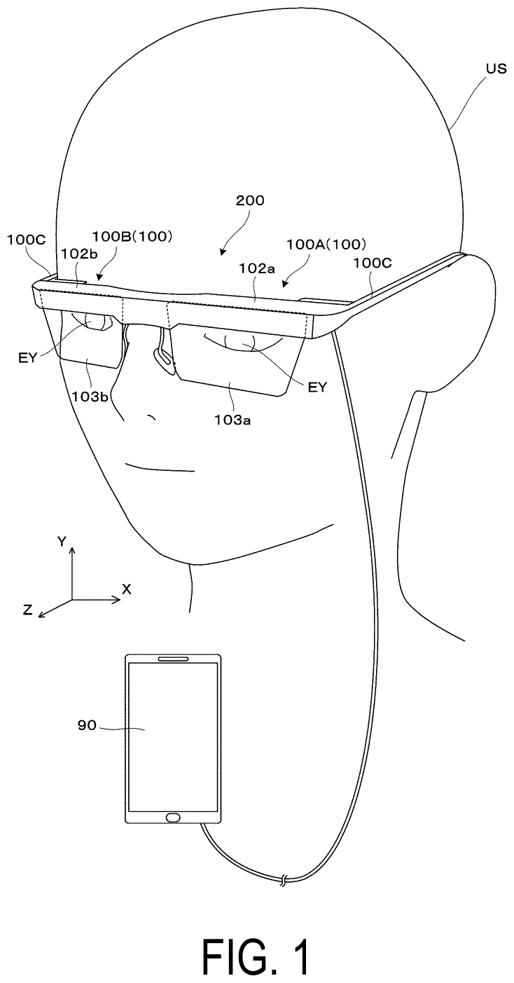

Below, a first embodiment of a virtual image display device according to the present disclosure will be described with reference to FIGS. 1 to 3 or the like.

FIG. 1 is a diagram for explaining a mounted state of a head-mounted display apparatus (hereinafter, also referred to as a head-mounted display or an “HMD”) 200, and the HMD 200 allows an observer or wearer US who is wearing the HMD 200 to recognize an image as a virtual image. In FIG. 1 or the like, X, Y, and Z represent a rectangular coordinate system. A +X direction corresponds to a lateral direction in which both eyes EY of the observer or the wearer US who wears the HMD 200 are arranged. A +Y direction corresponds to an upper direction perpendicular to the lateral direction from the viewpoint of the wearer US in which both the eyes EY are arranged. A +Z direction corresponds to a forward direction or a front side direction from the viewpoint of the wearer US. The ±Y direction is parallel to a vertical axis or a vertical direction.

The HMD 200 includes a left-eye first virtual image display device 100A, a right-eye second virtual image display device 100B, a pair of temple type support devices 100C that support the virtual image display devices 100A and 100B, and a user terminal 90 as an information terminal. The first virtual image display device 100A alone functions as an HMD, and includes a first display driving unit 102a arranged at an upper portion thereof, and a first light-guiding optical system 103a that has a spectacle lens shape and covers a front of an eye. The second virtual image display device 100B alone functions as an HMD similarly, and includes a second display driving unit 102b arranged at an upper portion thereof, and a second light-guiding optical system 103b that has a spectacle lens shape and covers a front of an eye. The support devices 100C are mounting members mounted on a head of the wearer US, and support upper end sides of the pair of light-guiding optical systems 103a and 103b via the display driving units 102a and 102b that are integrated in appearance. The first virtual image display device 100A and the second virtual image display device 100B are optically left-right inverted, and detailed description of the second virtual image display device 100B will be omitted.

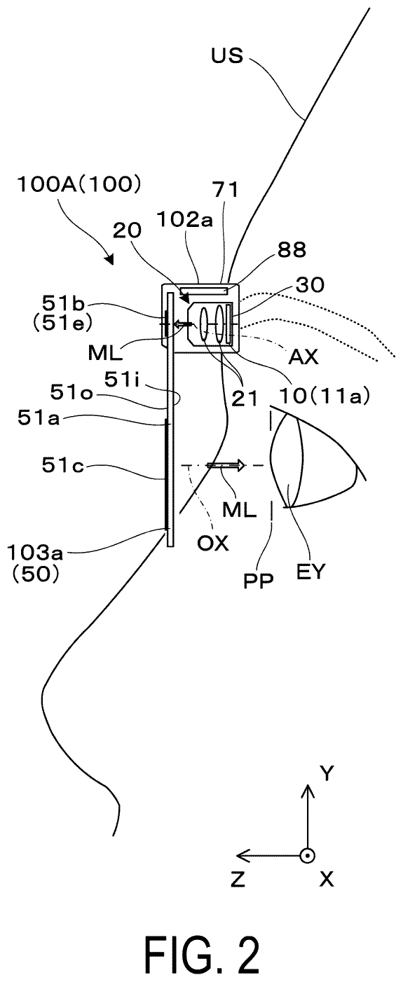

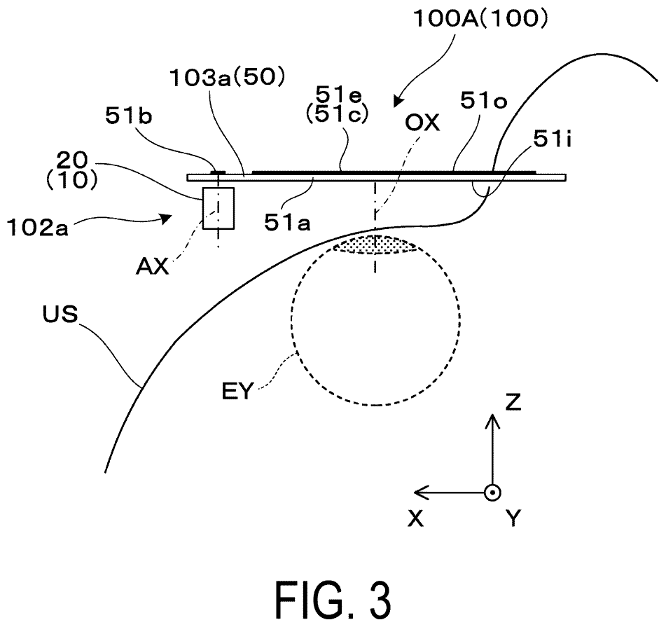

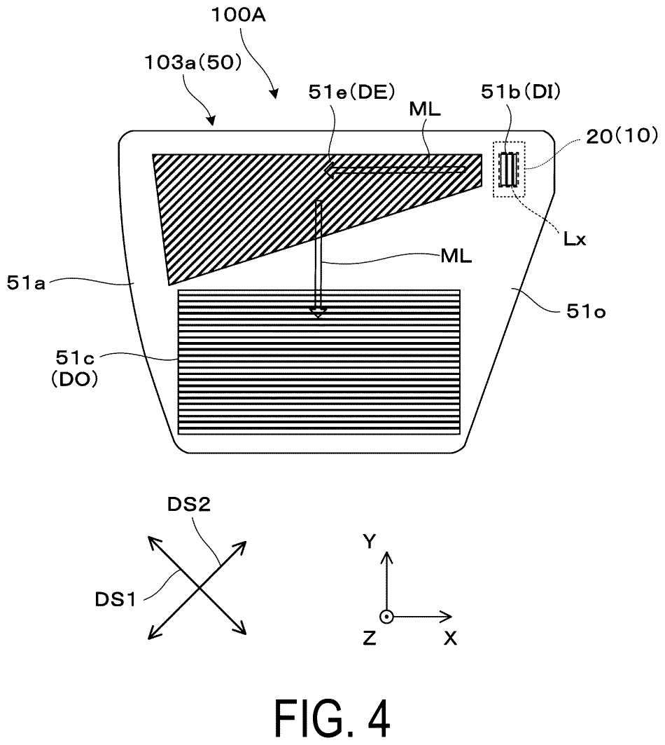

FIG. 2 is a side view for specifically describing the first display driving unit 102a and the first light-guiding optical system 103a of the first virtual image display device 100A. FIG. 3 is a plan view for specifically describing the first display driving unit 102a and the first light-guiding optical system 103a. FIG. 4 is a front view for describing the first light-guiding optical system 103a.

Referring to FIGS. 2 and 3, the first display driving unit 102a includes an image light generation device 10, a projection optical system 20, and a drive circuit member 88. The image light generation device 10 is an optical engine including a display panel 11a. The projection optical system 20 is a collimator including a plurality of lens elements 21. An image light beam ML generated by the image light generation device 10 is collimated by the projection optical system 20 and coupled to the first light-guiding optical system 103a which is a light-guiding member 50. The collimation is to optically adjust diffused light by an optical element so as to be in a parallel state to form collimated light, that is, parallel light. The drive circuit member 88 causes the display panel 11a to perform display operation. Note that in the first virtual image display device 100A, an optical device excluding the drive circuit member 88 is referred to as an optical unit 100. The first virtual image display device 100A guides the image light beam ML to the eyes EY of the observer US, and causes the observer US to visually recognize a virtual image.

Referring to FIG. 4, the first light-guiding optical system 103a is the light-guiding member 50 that enables color display, and extends substantially parallel to an XY plane. The first light-guiding optical system 103a includes a light-guiding plate 51a, an incidence diffraction layer 51b, a pupil expansion grating layer 51e, and an emission diffraction layer 51c. The incidence diffraction layer 51b, the emission diffraction layer 51c, and the pupil expansion grating layer 51e diffract the image light beam ML according to a wavelength thereof. The incidence diffraction layer 51b is an incidence portion DI, and guides the collimated image light beam ML from the first display driving unit 102a (see FIG. 2) into the light-guiding plate 51a to propagate the image light beam ML in the lateral direction. The pupil expansion grating layer 51e is a relay portion DE, and while expanding a pupil size of the image light beam ML propagating in the lateral direction in the light-guiding plate 51a, propagates the image light beam ML downward. The emission diffraction layer 51c is an emission portion DO, and while expanding the pupil size of the image light beam ML propagating downward in the light-guiding plate 51a, emits the image light beam ML toward a pupil position PP (see FIG. 2) set on an inside where the eye EY (see FIG. 2) is present.

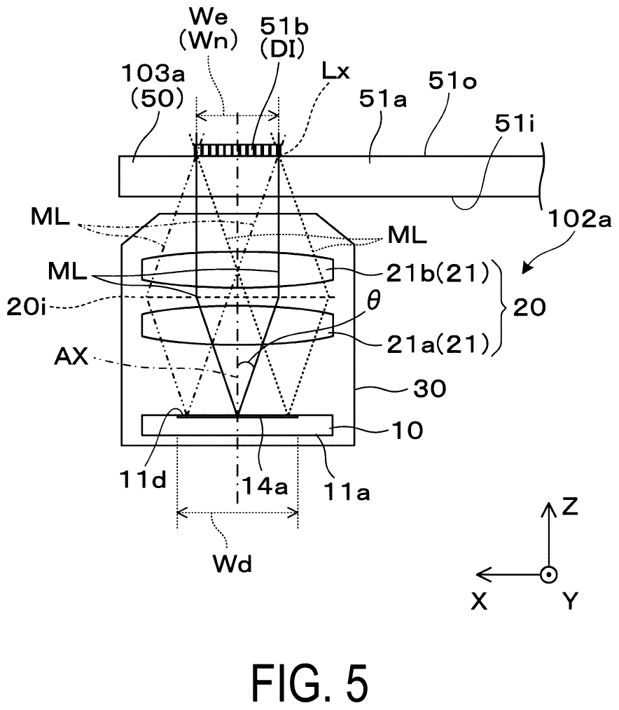

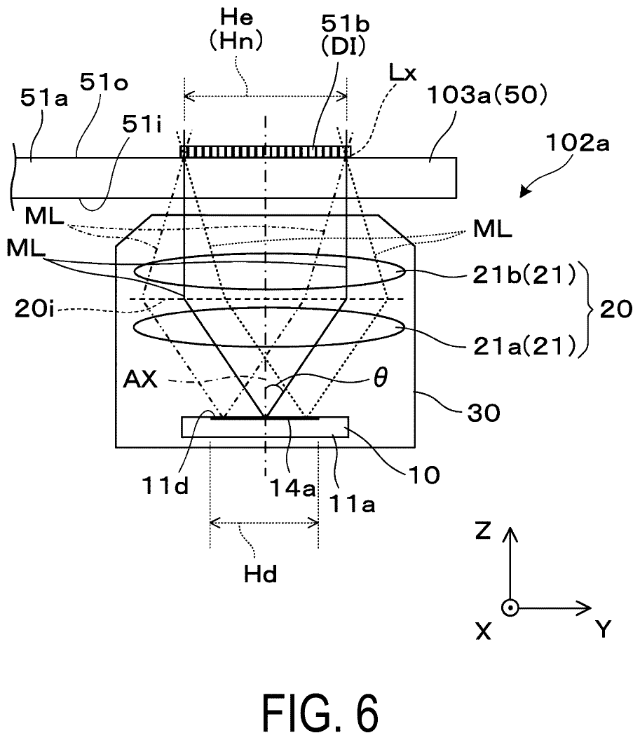

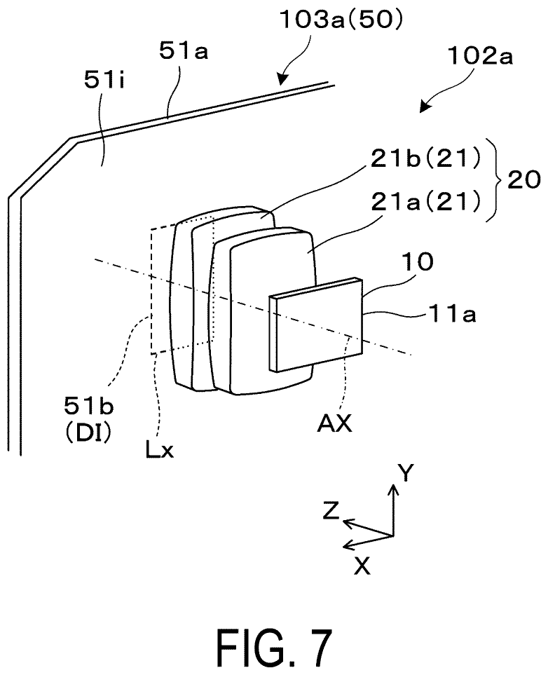

FIGS. 5 and 6 are conceptual plan view and side view for describing an optical system of the first display driving unit 102a. FIG. 7 is a conceptual perspective view for describing the optical system of the first display driving unit 102a. In the first display driving unit 102a, the image light generation device 10 includes only one display panel 11a. That is, the display panel 11a includes pixels of three colors of RGB, and the pixels of the respective colors are two dimensionally arrayed in the display panel 11a. The projection optical system 20 includes the plurality of lens elements 21. The display panel 11a and the projection optical system 20 are fixed in a state of being mutually positioned by a lens barrel 30. The lens barrel 30 is supported together with the drive circuit member 88 by a holder 71 (see FIG. 2) also serving as a cover while being mutually positioned, and is fixed to the first light-guiding optical system 103a.

The display panel 11a is a display element or a display device that emits the image light beam ML to form an image corresponding to a virtual image. To be more specific, the display panel 11a is a display of various light-emitting element arrays such as an organic light emitting diode (OLED), a micro OLED, an organic electro-luminescence (organic EL), an inorganic EL, a light emitting diode (LED), and a micro LED, and forms a still picture or a moving picture on a two dimensional display surface 11d parallel to the XY plane. Note that the OLED is included in an organic EL element. The display panel 11a includes a light-emitting element 14a. The light-emitting element 14a is formed by two dimensionally arraying a large number of pixel elements at a substrate along the XY plane, and when the display panel 11a is an OLED display, each of the pixel elements constituting the light-emitting element 14a includes a cathode, an electron-transporting layer, a light-emitting layer, a hole-transporting layer, and a transparent-electrode layer in this order from the substrate side.

The display panel 11a is not limited to a self-luminous image light generation device, is a display formed by of an LCD or other light modulation element, and may form an image by illuminating the light modulation element with a light source such as a background. As the display panel 11a, a liquid crystal on silicon (LCOS, LCOS is a trade name), a digital micromirror device (specifically, DLP: trade name), laser beam scanner, or the like can be used instead of an LCD.

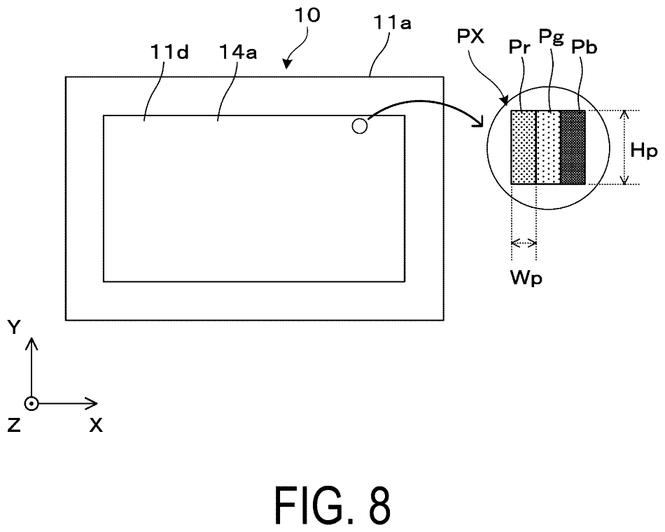

FIG. 8 is a plan view for describing the display surface 11d of the display panel 11a. The display surface 11d of the display panel 11a has a laterally long shape in which a lateral width Wp is larger than a vertical width Hp. Accordingly, the display panel 11a also has a laterally long shape. In the present embodiment, the lateral width Wp is a length in the lateral direction or a left-right direction, that is, an X direction, and the vertical width Hp is a length in a vertical direction or an up-down direction, that is, a Y direction. The lateral direction is a direction in which positions where the eyes EY are arranged are aligned, and a direction in which the light-guiding plate 51a extends. The vertical direction is a direction orthogonal to the lateral direction. When the image light generation device 10 includes only one display panel 11a, sub-pixels Pr, Pg, and Pb displaying the respective colors of RGB are two dimensionally arrayed, with the sub-pixels Pr, Pg, and Pb of RGB as one pixel Px (pixel element), in the display panel 11a. That is, the display panel 11a has a stripe structure of the three colors by the sub-pixels Pr, Pg, and Pb. Each of the sub-pixels Pr, Pg, and Pb has a vertically long shape. Therefore, the display panel 11a has a wider visual field angle characteristic in the up-down direction being the vertical direction, that is, the Y direction. Here, the visual field angle characteristic means a property that a contrast ratio, a color, or the like is viewed differently depending on a direction (angle) from which a screen is viewed.

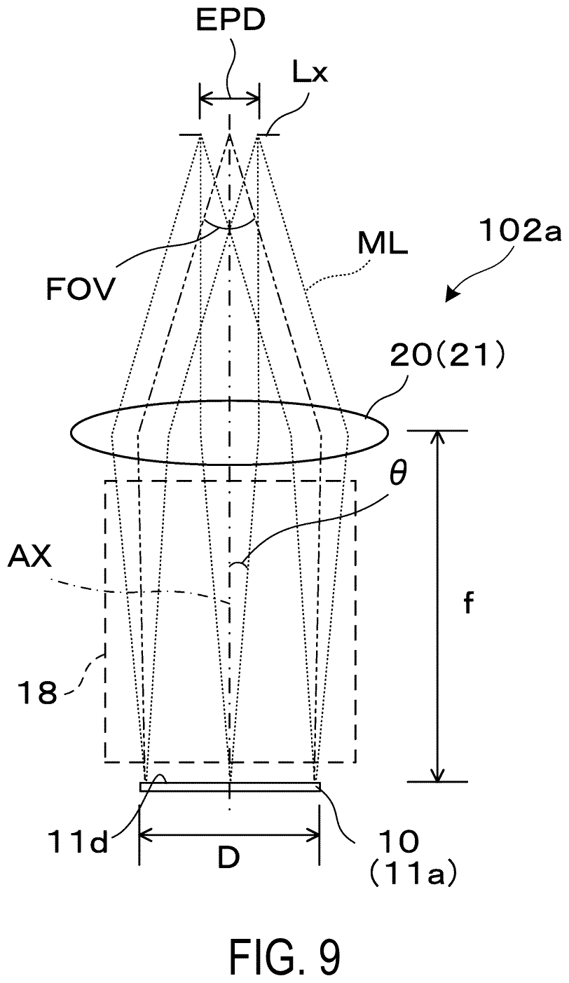

FIG. 9 is a conceptual view for describing an angle characteristic and the like of the first display driving unit 102a. In FIG. 9, a symbol FOV indicates a visual field angle. In the display panel 11a including the pixel Px of the vertically long stripe structure described above, in response to widening of the visual field angle characteristic in the up-down direction, an acceptance angle θ of the image light beam ML emitted from the display panel 11a is also larger in the vertical direction than in the lateral direction (see FIGS. 6 and 8). Therefore, an amount of irradiation light flux at an exit pupil position of the projection optical system 20 can be increased, and light utilization efficiency of the entire optical system can be improved. Here, the acceptance angle θ means an angle at which the projection optical system 20 can accept the image light beam ML emitted from the display panel 11a (angle of incident light with respect to an optical axis AX of the projection optical system 20).

The projection optical system 20 includes a first lens 21a and a second lens 21b as the lens elements 21 that collimate, that is, parallelize incident light. The projection optical system 20 has a function substantially equivalent to that of a single lens 20i, collimates the image light beam ML emitted from the display surface 11a of the display panel 11d into a state having a predetermined light beam width, and emits the image light beam ML toward the incidence diffraction layer 51b. The projection optical system 20 may include an optical element such as a reflection mirror, in addition to one or more lens elements formed of resin or glass. An optical surface of the optical element constituting the projection optical system 20 may be any one of a spherical surface, an aspherical surface, and a free form surface.

The light-guiding plate 51a is a member formed of a parallel flat plate, and includes a first total reflection surface 51i and a second total reflection surface 510 that form a pair of flat surfaces extending in the XY plane.

Returning to FIG. 4, in the first light-guiding optical system 103a or the light-guiding member 50, the incidence diffraction layer 51b, the emission diffraction layer 51c, and the pupil expansion grating layer 51e are formed at the second total reflection surface 510 of the light-guiding plate 51a. That is, the incidence diffraction layer 51b, the emission diffraction layer 51c, and the pupil expansion grating layer 51e are arranged on an external side, that is, on the +Z side, of the light-guiding plate 51a. The incidence diffraction layer 51b, the emission diffraction layer 51c, and the pupil expansion grating layer 51e are designed to function as a reflective diffraction grating that partially transmits external light.

The incidence diffraction layer 51b is an input diffraction optical element which is the incidence portion DI, and folds back the image light beam ML which is emitted from the display panel 11a of the image light generation device 10 and is incident through the lens element 21 of the projection optical system 20 so as to propagate inside the light-guiding member 50. The image light beam ML collimated around the optical axis AX (see FIG. 2) perpendicular to the light-guiding plate 51a is incident on the incidence diffraction layer 51b. The incidence diffraction layer 51b is formed with a diffraction pattern that extends linearly in the vertical Y direction and repeats periodically in the lateral X direction.

The pupil expansion grating layer 51e is a pupil expansion diffraction optical element being the relay portion DE, is provided on the −X side of the incidence diffraction layer 51b, and bends an optical path so that the image light beam ML, which is guided in the light-guiding plate 51a and advances as a whole in the −X direction, advances as a whole in the −Y direction. In the example of the present embodiment, the relay portion DE is an element that converts a propagation light guiding direction of the image light beam ML from the lateral direction to the vertical direction. The pupil expansion grating layer 51e does not substantially impair angle information about the left-right X direction of the image light beam ML and angle information about the upper-down Y direction of the image light beam ML while switching diffracting directions. The pupil expansion grating layer 51e expands a pupil of the emission diffraction layer 51c while guiding the image light beam ML guided from the incidence diffraction layer 51b into the light-guiding plate 51a to the emission diffraction layer 51c. To be more specific, the pupil expansion grating layer 51e is interposed between the incidence diffraction layer 51b and the emission diffraction layer 51c, while guiding the image light beam ML in a direction (the −Y direction) intersecting a diffraction direction (−X direction) of the incidence diffraction layer 51b, divides a light beam, and has a function of expanding a light beam width in the lateral direction. That is, the pupil expansion grating layer 51e expands a pupil in the lateral direction which is a first direction. The pupil expansion grating layer 51e is formed with a diffraction pattern that extends linearly in an oblique direction DS1 parallel to the XY plane and repeats periodically in a direction DS2 parallel to the XY plane and perpendicular to the direction DS1. The direction DS1 is a direction rotated counterclockwise by 45° with respect to the +Y direction, and is an intermediate direction between the −X direction and the +Y direction. A grating period or a pitch in the X direction and the Y direction of a pattern formed at the pupil expansion grating layer 51e matches with a grating period in the X direction of a pattern formed at the incidence diffraction layer 51b and a grating period in the Y direction of a pattern formed at the emission diffraction layer 51c.

The emission diffraction layer 51c is an output diffraction optical element being the emission portion DO, divides a light beam while guiding the image light beam ML in the −Y direction, and has a function of expanding a light beam width in the vertical direction. That is, the emission diffraction layer 51c enlarges a pupil in the vertical direction which is a second direction orthogonal to the first direction. As a result, the light beam widths in the X direction and the Y direction of the image light beam ML incident on the pupil position PP illustrated in FIG. 2 each have a spread corresponding to the emission diffraction layer 51c, and the pupil sizes in the vertical direction and the lateral direction increase through the pupil expansion grating layer 51e, the emission diffraction layer 51c, and the like. The image light beam ML collimated around an emission optical axis OX (see FIG. 2) perpendicular to the light-guiding plate 51a is emitted from the emission diffraction layer 51c. The image light beam ML emitted from the emission diffraction layer 51c forms an angle of about +25° with respect to the emission optical axis OX. That is, an angle of view of the first virtual image display device 100A is about 50°. The emission diffraction layer 51c is formed with a diffraction pattern that extends linearly in the lateral X direction and repeats periodically in the vertical Y direction.

The incidence diffraction layer 51b, the emission diffraction layer 51c, and the pupil expansion grating layer 51e are formed of, for example, a surface-relief-type diffraction element. The surface-relief-type diffraction element is formed by nanoimprinting, but are not limited thereto, and may be formed by etching a front surface of the light-guiding plate 51a, or may be formed by bonding a diffraction element. A material of the diffraction grating is a nano-imprint material when fabricated by nano-imprint, and is the same material as that of the light-guiding plate 51a when fabricated by etching. The material of the light-guiding plate 51a is, for example, glass or resin.

Hereinafter, shapes, dimensions, and the like of the display panel 11a, the projection optical system 20, and the incidence diffraction layer 51b will be collectively described with reference to FIGS. 5 and 6.

The display surface 11d of the display panel 11a has a laterally long shape in which a lateral width Wd is larger than a vertical width Hd, corresponding to an exit pupil Lx. The sub-pixels Pr, Pg, and Pb of the respective colors in the display panel 11a each have a vertically long shape in which the vertical width Hp is larger than the lateral width Wp, correspondingly to the exit pupil Lx (see FIG. 8). That is, a visual field angle characteristic of the image light beam ML has a wider angle characteristic in the vertical direction than in the lateral direction, correspondingly to the exit pupil Lx. The angle characteristic can be achieved by providing a vertically long sub-pixel in the display panel 11a or providing a vertically long lens in the lens element 21 as will be described later. The exit pupil Lx of the projection optical system 20 has a vertically long shape in which a vertical width He is larger than a lateral width We. The shape of the exit pupil Lx is a contour shape of the image light beam ML with respect to a plane perpendicular to the optical axis AX. The shape of the exit pupil Lx mainly depends on a light distribution characteristic of the pixels of the display panel 11a based on the projection optical system 20 that superimposes the collimated image light beam ML on the pupil position, and when there is an optical element that affects a light distribution characteristic, the shape is affected by the optical element that affects the characteristic, and is affected by an opening shape of the projection optical system 20 and a size of the display panel 11a. In addition, the lenses 21a and 21b of the lens element 21 each have a vertically long shape in which a vertical width is larger than a lateral width, correspondingly to the exit pupil Lx. That is, the lenses 21a and 21b each have a vertically thin and long shape. The incidence diffraction layer 51b being the incidence portion DI has a vertically long shape in which a vertical width Hn is larger than a lateral width Wn, correspondingly to the exit pupil Lx. A size of the incidence diffraction layer 51b is the same as that of the exit pupil Lx, but may be slightly larger than the size of the exit pupil Lx. Thus, in the incidence diffraction layer 51b, an optical loss of the image light beam ML from the projection optical system 20 can be reduced.

In order to reduce the projection optical system 20 in size, it is necessary to reduce the incidence diffraction layer 51b. To be specific, the lateral width Wn of the incidence diffraction layer 51b is, for example, about 1 mm, and the vertical width Hn thereof is, for example, about 2 mm. The exit pupil Lx of the projection optical system 20 has the lateral width We of, for example, about 1 mm and the vertical width He of, for example, about 2 mm so as to correspond to the incidence diffraction layer 51b. Accordingly, the lateral width of the projection optical system 20 can be reduced, and AR (augmented reality) glasses that are close in shape to eyeglasses can be achieved.

In the above description, when the incidence diffraction layer 51b is vertically long, it is desirable that light is first guided by being folded back in the lateral direction which is a short side direction of the incidence diffraction layer 51b. This is because when light is guided by the light-guiding plate 51a, in a case where the light enters the incidence diffraction layer 51b again, a loss occurs.

The virtual image display devices 100A and 100B in the first embodiment each include the display panel 11a configured to emit the image light beam ML, the projection optical system 20 configured to collimate the image light beam ML from the display panel 11a, and the light-guiding member 50 including the light-guiding plate 51a that guides the image light beam ML, the incidence portion DI that causes the image light beam ML to enter the light-guiding plate 51a, the relay portion DE that guides the image light beam ML passing through the incidence portion DI and enlarges the pupil in the first direction, and the emission portion DO that guides the image light beam ML passing through the relay portion DE, enlarges the pupil in the second direction orthogonal to the first direction, and emits the image light beam ML from the light-guiding plate 51a, wherein the exit pupil Lx of the projection optical system 20 has the shape in which the vertical width He is larger than the lateral width We, and the incidence portion DI has the shape in which the vertical width Hn is larger than the lateral width Wn, correspondingly to the shape of the exit pupil Lx.

In each of the above-described virtual image display devices 100A and 100B, since the exit pupil Lx at the time of irradiation of the light-guiding plate 51a by the projection optical system 20 is larger in the vertical direction than in the lateral direction, the lateral width of the projection optical system 20 can be reduced, and the amount of irradiation light flux can be increased. As a result, while the virtual image display devices 100A and 100B can be brought close to a spectacle shape by reducing the projection optical system 20 in size, brightness of light emitted from the light-guiding member 50 or the light-guiding plate 51a can be improved, and light utilization efficiency can be improved.

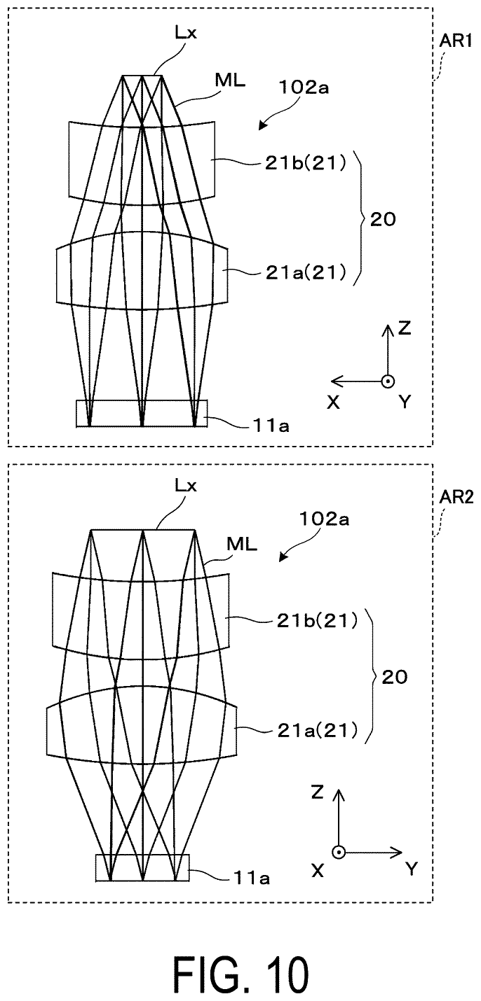

FIG. 10 is an optical path view for describing a modification of the optical system of the first display driving unit 102a. In FIG. 10, a region AR1 represents a lateral cross-section of the optical system of the first display driving unit 102a, and a region AR2 represents a vertical cross-section of the optical system of the first display driving unit 102a. As illustrated in FIG. 10, the optical system of the first display driving unit 102a in the present embodiment is not limited to a telecentric optical system, but may be a non-telecentric optical system. However, a design of the telecentric optical system is optimal depending on conditions such as the visual field angle FOV and the panel size of the display panel 11a.

### Second Embodiment

A virtual image display device according to a second embodiment of the present disclosure is described below. Note that the virtual image display device of the second embodiment is a partial modification of the virtual image display device of the first embodiment, and description of common parts is omitted.

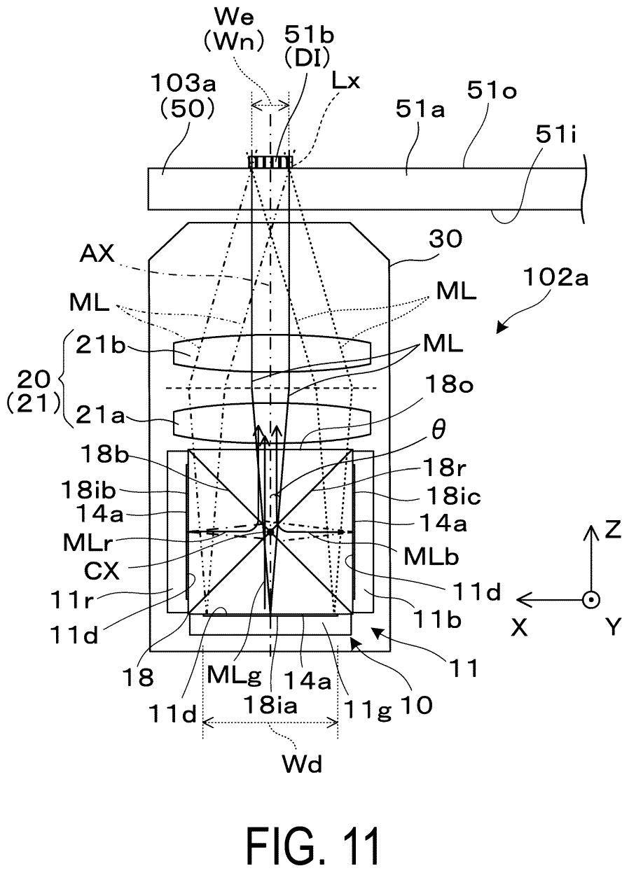

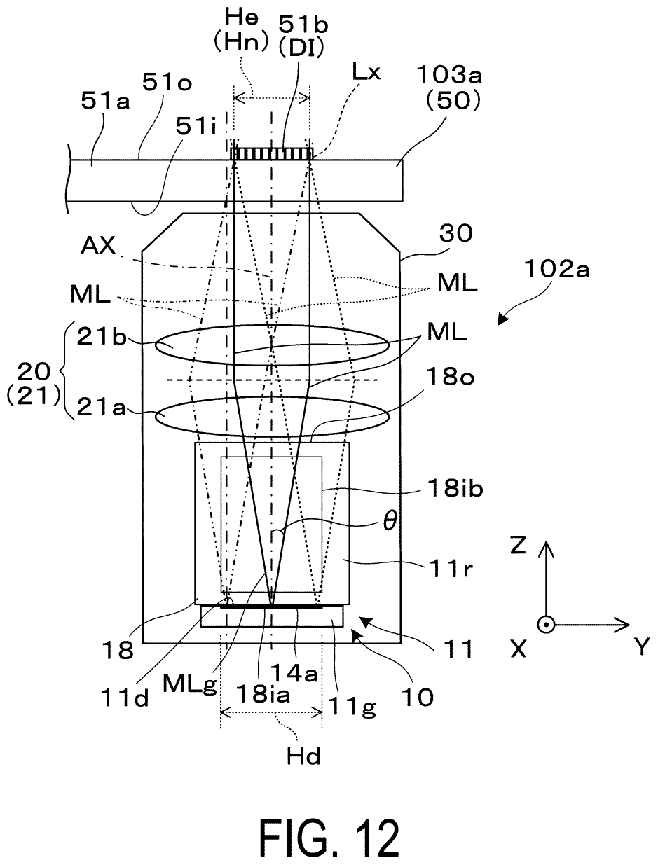

FIGS. 11 and 12 are conceptual plan view and side view for describing the optical system of the first display driving unit 102a. In the first display driving unit 102a, the image light generation device 10 of the first display driving unit 102a includes three display panels 11r, 11b, and 11g, and a cross dichroic prism 18. The projection optical system 20 is a collimator including the plurality of lenses 21a and 21b which are the lens elements 21.

The display panel 11r for red is a first display panel, and emits a red image light beam MLr which is a first image light beam. The display panel 11r is, for example, a micro OLED display, forms a still picture or a moving picture on the two-dimensional display surface 11d parallel to a YZ plane, and emits the red image light beam MLr.

The display panel 11b for blue is a second display panel, and emits a blue image light beam MLb which is a second image light beam. The display panel 11b is, similar to the display panel 11r for red, a micro OLED display, forms a still picture or a moving picture on the two-dimensional display surface 11d parallel to the YZ plane, and emits the blue image light beam MLb. The light-emitting element 14a incorporated in the display panel 11b for blue has a different light emission wavelength from that of the light-emitting element 14a of the display panel 11r for red. That is, the blue image light beam MLb which is the second image light beam and the red image light beam MLr which is the first image light beam are different in wavelength range.

The display panel 11g for green is a third display panel, and emits a green image light beam MLg which is a third image light beam. The display panel 11g is, similar to the display panel 11r for red, a micro OLED display, forms a still picture or a moving picture on the two-dimensional display surface 11d parallel to the XY plane, and emits the green image light beam MLg. The light-emitting element 14a incorporated in the display panel 11g for green has a different light emission wavelength from those of the light-emitting elements 14a of the display panels 11r and 11b for red and blue. That is, the green image light beam MLg which is the third image light beam, the red image light beam MLr which is the first image light beam, and the blue image light beam MLb which is the second image light beam are different in wavelength range.

Each of the light-emitting elements 14a incorporated in the display panels 11r, 11b, and 11g is a micro OLED display provided with a primary resonance type cavity. Therefore, in an orientation characteristic of each of the display panels 11r, 11b, and 11g, light intensity is large in a front direction parallel to the optical axis AX, and the light intensity rapidly decreases in a direction slightly inclined with respect to the front direction. Assuming that an angle at which the light intensity becomes half is a radiation angle, a radiation angle of the red image light beam MLr from a pixel, a radiation angle of the blue image light beam MLb from the pixel, and a radiation angle of the green image light beam MLg from the pixel are within about 20°. Dichroic mirrors 18r and 18b of the cross dichroic prism 18, which will be described later, are designed based on the radiation angles of these image light beams MLr, MLb, and MLg.

The display panel 11r for red is fixed so as to be attached to a first light incident surface 18ib of the cross dichroic prism 18. The first display panel 11r for red causes the red image light beam MLr, which is the first image light beam, to enter the cross dichroic prism 18 from the first light incident surface 18ib. The display panel 11b for blue is fixed so as to be attached to a second light incident surface 18ic of the cross dichroic prism 18. The second display panel 11b for blue causes the blue image light beam MLb, which is the second image light beam, to enter the cross dichroic prism 18 from the second light incident surface 18ic. The display panel 11g for green is fixed so as to be attached to a third light incident surface 18ia of the cross dichroic prism 18. The third display panel 11g for green causes the green image light beam MLg, which is the third image light beam, to enter the cross dichroic prism 18 from the third light incident surface 18ia.

The cross dichroic prism 18 is obtained by joining four right-angled triangular prisms formed of a glass material or the like so that right-angled edges coincide with each other, and has a structure in which the two dichroic mirrors 18r and 18b orthogonal to each other are embedded in joint portions of the prisms. The dichroic mirror 18r on one side is arranged to form an angle of 45° with the first light incident surface 18ib. The dichroic mirror 18r forms a surface linking diagonal corners of a square contour when viewed in a direction of an intersecting axis CX of the cross dichroic prism 18. The dichroic mirror 18b on another side is arranged to form an angle of 45° with the second light incident surface 18ic. The dichroic mirror 18b forms a surface linking diagonal corners of the square contour when viewed in the direction of the intersecting axis CX of the cross dichroic prism 18.

The red image light beam MLr incident on the first light incident surface 18ib of the cross dichroic prism 18 from the first display panel 11r for red is reflected by the dichroic mirror 18r, is bent toward an emission side, that is, the projection optical system 20, and is emitted from a light emission surface 180 outward in the +Z direction. The blue image light beam MLb incident on the second light incident surface 18ic of the cross dichroic prism 18 from the second display panel 11b for blue is reflected by the dichroic mirror 18b, is bent toward the emission side, that is, the projection optical system 20, and is emitted from the light emission surface 180 outward in the +Z direction. The green image light beam MLg incident on the third light incident surface 18ia of the cross dichroic prism 18 from the third display panel 11g for green passes toward the projection optical system 20 without being reflected by the dichroic mirror 18r or 18b, and is emitted from the light emitting surface 180 outward in the +Z direction. That is, the cross dichroic prism 18 transmits the green image light beam MLg. As a result, synthesis of an image in which the red image light beam MLr, the green image light beam MLg, and the blue image light MLb are superimposed is performed by the cross dichroic prism 18, the image is emitted as the image light beam ML, and can be caused to enter the projection optical system 20.

In the cross dichroic prism 18, the intersecting axis CX extends along a line of intersection of the two dichroic mirrors 18r and 18b, and is parallel to the Y direction. The optical axis AX passing through the light emission surface 180 of the cross dichroic prism 18 extends in the lateral direction perpendicular to the light-guiding plate 51a, that is, in the Z direction.

The projection optical system 20 is an optical system that is substantially telecentric with respect a side of the display panels 11r, 11b, and 11g, which is an object side. That is, main light beams of the image light beams 11r, 11b, and 11g emitted from respective portions of the light-emitting elements 14a which are the display surfaces 11d of the respective display panels 11r, 11b, and 11g pass through the light incident surfaces 18ib, 18ic, and 18ia of the cross dichroic prism 18 in a state substantially parallel to the optical axis AX, and thus enter into the cross dichroic prism 18, and are emitted from the cross dichroic prism 18 substantially parallel to the optical axis AX. Accordingly, the red image light beam MLr, the green image light beam MLg, and the blue image light beam MLb within a predetermined angle range or less are incident on the dichroic mirrors 18r and 18b, and it is possible to suppress an optical loss due to the dichroic mirrors 18r and 18b.

Note that the arrangement of the display panels 11r, 11b, and 11g can be changed as appropriate.

An angle characteristic of each of the dichroic mirrors 18r and 18b is widened corresponding to a long side of the exit pupil Lx or the incidence diffraction layer 51b. The intersecting axis CX of the dichroic mirrors 18r and 18b extends along the vertical direction of the light-guiding member 50 or the light-guiding plate 51a. In the cross dichroic prism 18, a traveling direction of the image light beam ML before being bent by the dichroic mirror 18r or 18b coincides with the lateral direction of the incidence diffraction layer 51b. In other words, a length in the traveling direction of the image light beam ML before being bent by the dichroic mirror 18r or 18b corresponds to the lateral width Wn of the incidence diffraction layer 51b. At the time of being worn, a short-side direction of the incidence diffraction layer 51b is a horizontal direction.

In an optical system in which light beams are synthesized by the plurality of display panels 11r, 11b, and 11g, and the dichroic mirrors 18r, and 18b, since a single-color light source is used for each panel, unlike an optical system in which three-color display is performed by one panel, a light-emitting layer can have a single-color structure. In addition, the above-described optical system for synthesizing light beams can achieve high brightness because there is no decrease in an amount of light due to a color filter, and is effective for achieving practical brightness even in an optical system having low brightness efficiency such as an optical system in which a pupil expansion light-guiding plate including a diffraction element as in the present embodiment is used. The cross dichroic prism 18 for synthesizing the three colors has, as a characteristic of each of the dichroic mirrors 18r and 18b, a characteristic of reflection and transmission in different wavelength ranges for the respective colors of RGB. In general, since the reflection and transmission characteristics and a wavelength characteristic shift depending on an angle of a light beam incident on the dichroic mirror 18r or 18b, it is necessary to limit an incident angle to some extent with respect to a light source having somewhat broad light such as an organic light emitting diode. For example, in the red-reflecting dichroic mirror 18r, a switching region between transmission and reflection (to be specific, a switching region between green transmission and red reflection) needs to fall within a range of 550 nm to 630 nm in an entire angle range. For example, in the blue-reflecting dichroic mirror 18b, a switching region between transmission and reflection (to be specific, a switching region between blue transmission and green reflection) needs to fall within a range of 470 nm to 530 nm in an entire angle range. In order to satisfy this condition, as a condition for the incident angle of the red image light beam MLr or the blue image light beam MLb on the dichroic mirror 18r or 18b, the incident angle needs to be+7° or less with respect to an inclination angle of the dichroic mirror 18r or 18b.

As illustrated in FIG. 9, when the visual field angle of the projection optical system 20 is FOV, an exit pupil size is EPD, a panel size is D, a focal distance of the projection optical system 20 is f, and an acceptance angle (half angle) of a light beam emitted from the display panel 11a is 0, the following relational expressions are established. Note that the panel size D is a size of the display surface 11a of the display panel 11d.

$$f = EPD / 2 tan θ$$

$$f = D / 2 tan ( FOV / 2 )$$

$$tan ( FOV / 2 ) = D tan θ / EPD$$

According to the above-described relational expressions, when there is a limitation on the acceptance angle θ, it is necessary to increase the panel size D or decrease the exit pupil size EPD. When the panel size D is increased, the cross dichroic prism 18 being a synthetic prism is also increased in size, so that the entire projection optical system 20 is increased. In this case, it is necessary to arrange the projection optical system 20 so as not to interfere with a face of the wearer US, and a lateral width of the first virtual image display device 100A is increased, which causes influence such as a deviation from the design of the HMD 200 and an increase in weight. Further, when the exit pupil size EPD is decreased, the projection optical system 20 can be decreased, but the amount of irradiation light flux at the exit pupil position is decreased and the brightness of the optical system is reduced.

In view of the above, it is necessary to increase the size of the exit pupil Lx while maintaining lateral widths of the display panels 11r, 11b, and 11g and the lateral width of the projection optical system 20 in order to achieve both the spectacle shape design of the HMD 200 and the brightness efficiency. As described above, the incident angle is limited for the cross dichroic prism 18, and an angle of reflection is basically 45°. In other words, a main light beam angle of each angle of view is based on a panel normal direction. Further, basically parallel light is incident on the light-guiding plate 51a, thus the projection optical system 20 causes the light to enter as a one-side telecentric optical system. In order to achieve the above-described configuration, the exit pupil Lx is formed such that the vertical width He is larger than the lateral width We and the vertical width Hn of the incidence diffraction layer 51b of the light-guiding plate 51a is larger than the lateral width Wn.

As illustrated in FIGS. 11 and 12, the display surface 11d of the display panel 11g has a laterally long shape in which the lateral width Wd is larger than the vertical width Hd. In the present embodiment, the vertical width Hd and the lateral width Wd of the display surface 11d of the display panel 11g are based on the third display panel 11g for green arranged to face the light-guiding member 50. The first display panel 11r for red and the second display panel 11b for blue each have a similar shape to that of the third display panel 11g for green. Each of the dichroic mirrors 18r and 18b is arranged so as to be inclined by 45° in the lateral direction with respect to the optical axis AX. An allowable range for the incident angle on the dichroic mirror 18r or 18b is 45+7° or less in a medium of the cross dichroic prism 18. The projection optical system 20 is designed to be one-side telecentric. The main light beams from the display panels 11r, 11b, and 11g are perpendicular to the display surfaces 11d of the display panels 11r, 11b, and 11g, respectively. Here, when the incident angle exceeds 45+7°, a light beam which is supposed to be reflected or transmitted is not reflected or transmitted at some wavelengths, and a remarkable color change and a decrease in brightness occur in a peripheral portion of the exit pupil Lx of the projection optical system 20.

Here, when a visual field angle in the lateral direction is large, the size of the cross dichroic prism 18 is increased, and large influence is exerted on the size of the projection optical system 20 itself. Therefore, by increasing the exit pupil Lx in the vertical direction such that the wider visual field angle FOV can be used in the vertical direction than in the lateral direction, enlargement of the cross dichroic prism 18 can be suppressed, a back focus of the projection optical system 20 can be reduced, and the size of the projection optical system 20 can be decreased.

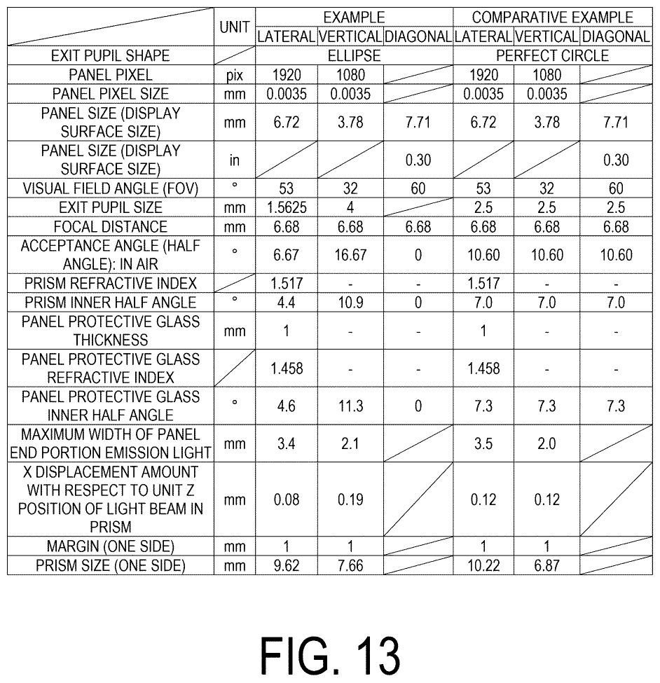

FIG. 13 is a diagram for describing a design example of the exit pupil size EPD when it is necessary to suppress the incident angle on each of the dichroic mirrors 18r and 18b in the cross dichroic prism 18 to +7°. FIG. 13 illustrates a calculation example in which differences in sizes of the cross dichroic prism 18 between the exit pupil Lx having a vertically long elliptical shape as an example, and the exit pupil Lx having a perfect circular shape as a comparative example are compared. The panel size D is 0.3 inch and the visual field angle FOV is 60°. According to this calculation, the size in the lateral direction of the cross dichroic prism 18 can be decreased from 10.2 mm to 9.6 mm by forming the shape of the exit pupil Lx in a vertically long elliptical shape. This makes it possible to achieve weight reduction by reducing the prism size, and to decrease the size of the projection optical system 20 by reducing a distance to the lens element 21.

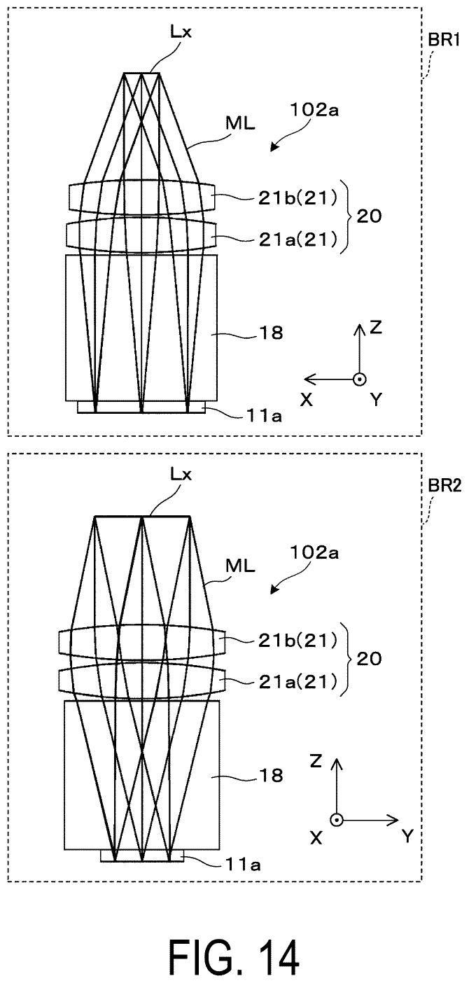

FIG. 14 is an optical path diagram illustrating an example of specific light beams in the optical system of the first display driving unit 102a in the present embodiment. In FIG. 14, a region BR1 represents a lateral cross-section of the optical system of the first display driving unit 102a, and a region BR2 represents a vertical cross-section of the optical system of the first display driving unit 102a. An aspect ratio of each of the lenses 21a and 21b of the projection optical system 20 changes depending on conditions such as the visual field angle FOV and the panel size D of the display panel 11a. For example, depending on the conditions such as the visual field angle FOV and the panel size D of the display panel 11a, in particular, the aspect ratio of the second lens 21a on the display panel 11a side may be substantially the same. In addition, an optical system in which the cross dichroic prism 18 is used can be brought into a non-telecentric state inclined inward, depending on design conditions such as the panel size D and the visual field angle FOV, and allowable conditions for an incident angle of a light flux by the design of the dichroic mirrors 18r and 18b. Thus, the cross dichroic prism 18 can have a further reduced configuration.

### Others

The structures described above are examples and various modifications can be made without departing from the scope capable of achieving the same functions.

The light-guiding member 50 may be formed by overlaying a plurality of light guides in parallel. In this case, respective light-guides of a constituent element can be formed so as to correspond to the three colors of RBG, for example. Each light-guide includes the light-guiding plate 51a, the incidence diffraction layer 51b, the emission diffraction layer 51c, and the pupil expansion grating layer 51e.

The incidence diffraction layer 51b, the emission diffraction layer 51c, and the pupil expansion grating layer 51e are not limited to diffraction elements, but may be formed of volumetric holograms. In addition, the incidence portion DI, the relay portion DE, and the emission portion DO are not limited to those that diffract the image light beam ML, and may be deflection branching portions that change a direction of the image light beam ML. Specifically, the incidence diffraction layer 51b, the emission diffraction layer 51c, and the pupil expansion grating layer 51e may be dielectric multilayer mirrors or metal mirrors. Each of the incidence diffraction layer 51b, the emission diffraction layer 51c, and the pupil expansion grating layer 51e is not limited to a layer formed of a single layer, but may be a layer in which a plurality of functional layers adapted to a wavelength of the image light beam ML or the like are stacked.

The incidence diffraction layer 51b, the emission diffraction layer 51c, and the pupil expansion grating layer 51e may be formed at the first total reflection surface 51i of the light-guiding plate 51a. In this case, the incidence diffraction layer 51b, the emission diffraction layer 51c, and the pupil expansion grating layer 51e are designed to function as transmission type diffraction gratings.

Although it has been described above that each of the virtual image display devices 100A and 100B can be used as an HMD, the present disclosure is not limited thereto and can be applied to various optical devices, for example, a head-up display (HUD).

A virtual image display device in a specific aspect includes a display panel configured to emit an image light beam, a projection optical system configured to collimate the image light beam from the display panel, and a light-guiding member including a light-guiding plate that guides the image light beam, an incidence portion that causes the image light beam to enter the light-guiding plate, a relay portion that guides the image light beam passing through the incidence portion and enlarges a pupil in a first direction, and an emission portion that guides the image light beam passing through the relay portion, enlarges the pupil in a second direction orthogonal to the first direction, and emits the image light beam from the light-guiding plate, wherein an exit pupil of the projection optical system has a shape in which a vertical width is larger than a lateral width, and the incidence portion has a shape in which a vertical width is larger than a lateral width, correspondingly to the shape of the exit pupil.

In the above-described virtual image display device, since the exit pupil at the time of irradiation of the light-guiding plate by the projection optical system is larger in a vertical direction than in a lateral direction, the lateral width of the projection optical system can be reduced, and an amount of irradiation light flux can be increased. As a result, while the virtual image display device can be brought close to a spectacle shape by reducing the projection optical system in size, brightness of light emitted from the light-guiding member of the light-guiding plate can be improved, and light utilization efficiency can be improved.

In the virtual image display device in a specific aspect, the first direction is the lateral direction, the second direction is the vertical direction, the vertical width is a size in the second direction, and the lateral width is a size in the first direction. When the incidence portion has a vertically long shape, it is possible to suppress a loss of guided light by first guiding the light so as to be folded back in the lateral direction which is a short side direction of the incidence portion.

In the virtual image display device in a specific aspect, the incidence portion, the emission portion, and the relay portion are formed by any one of a diffraction element, a volume hologram, a dielectric multilayer mirror, and a metal mirror.

In the virtual image display device in a specific aspect, a visual field angle characteristic of the image light beam emitted from the display panel has an angle characteristic wider in the vertical direction than in the lateral direction, correspondingly to the exit pupil.

In the virtual image display device in a specific aspect, the projection optical system includes a lens having a shape in which a vertical width is larger than a lateral width, correspondingly to the exit pupil. In this case, a size of the projection optical system can be reduced.

In the virtual image display device in a specific aspect, a sub-pixel for each color in the display panel has a shape in which a vertical width is larger than a lateral width, correspondingly to the exit pupil. In this case, a visual field angle characteristic of the display panel is widened in the vertical direction.

The virtual image display device in a specific aspect, a first display panel being a display panel configured to emit a first image light beam of the image light beam, a second display panel configured to emit a second image light beam different from the first image light beam in wavelength range, a third display panel configured to emit a third image light beam different from the first image light beam and the second image light beam in wavelength range, and a cross dichroic prism configured to synthesize the first image light beam, the second image light beam, and the third image light beam. As described above, by synthesizing the first image light beam, the second image light beam, and the third image light beam, it is possible to display a virtual image with high brightness.

In the virtual image display device in a specific aspect, an angle characteristic of the dichroic mirror of the cross dichroic prism is wide corresponding to a long side of the exit pupil, an intersecting axis of the dichroic mirror is along a vertical direction of the light-guiding member, and in the cross dichroic prism, a length in a traveling direction of the image light beam before being bent by the dichroic mirror corresponds to a lateral width of the incidence portion.

In the virtual image display device in a specific aspect, the display panel is any one of an organic EL display, a micro LED display, a reflective liquid crystal display, and a digital micromirror device.

An optical unit in a specific aspect includes a display panel configured to emit an image light beam, a projection optical system configured to collimate the image light beam from the display panel, and a light-guiding member including a light-guiding plate that guides the image light beam, an incidence portion that causes the image light beam to enter the light-guiding plate, a relay portion that guides the image light beam passing through the incidence portion and enlarges a pupil in a first direction, and an emission portion that guides the image light beam passing through the relay portion, enlarges the pupil in a second direction orthogonal to the first direction, and emits the image light beam from the light-guiding plate, wherein an exit pupil of the projection optical system has a shape in which a vertical width is larger than a lateral width, and the incidence portion has a shape in which a vertical width is larger than a lateral width, correspondingly to the shape of the exit pupil.

What is claimed is:

1. A virtual image display device, comprising:
a display panel configured to emit an image light beam;
a projection optical system configured to collimate the image light beam from the display panel; and
a light-guiding member including a light-guiding plate that guides the image light beam, an incidence portion that causes the image light beam to enter the light-guiding plate, a relay portion that guides the image light beam passing through the incidence portion and enlarges a pupil in a first direction, and an emission portion that guides the image light beam passing through the relay portion, enlarges the pupil in a second direction orthogonal to the first direction, and emits the image light beam from the light-guiding plate, wherein
an exit pupil of the projection optical system has a shape in which a vertical width is larger than a lateral width, and
the incidence portion has a shape in which a vertical width is larger than a lateral width, correspondingly to the shape of the exit pupil.

2. The virtual image display device according to claim 1, wherein
the first direction is a lateral direction, the second direction is a vertical direction, and
the vertical width is a size in the second direction, and the lateral width is a size in the first direction.

3. The virtual image display device according to claim 1, wherein
the incidence portion, the emission portion, and the relay portion are formed by any one of a diffraction element, a volume hologram, a dielectric multilayer mirror, and a metal mirror.

4. The virtual image display device according to claim 1, wherein
a visual field angle characteristic of the image light beam emitted from the display panel has an angle characteristic wider in a vertical direction than in a lateral direction, correspondingly to the exit pupil.

5. The virtual image display device according to claim 1, wherein
the projection optical system includes a lens having a shape in which a vertical width is larger than a lateral width, correspondingly to the exit pupil.

6. The virtual image display device according to claim 1, wherein
a sub-pixel for each color in the display panel has a shape in which a vertical width is larger than a lateral width, correspondingly to the exit pupil.

7. The virtual image display device according to claim 1, comprising:
a first display panel being the display panel configured to emit a first image light beam of the image light beam;
a second display panel configured to emit a second image light beam different from the first image light beam in wavelength range;
a third display panel configured to emit a third image light beam different from the first image light beam and the second image light beam in wavelength range; and
a cross dichroic prism configured to synthesize the first image light beam, the second image light beam, and the third image light beam.

8. The virtual image display device according to claim 7, wherein
an angle characteristic of a dichroic mirror of the cross dichroic prism is wide corresponding to a long side of the exit pupil,
an intersecting axis of the dichroic mirror is along a vertical direction of the light-guiding member, and in the cross dichroic prism, a length in a traveling direction of the image light beam before being bent by the dichroic mirror corresponds to a lateral width of the incidence portion.

9. The virtual image display device according to claim 1, wherein
the display panel is any one of an organic EL display, a micro LED display, a reflective liquid crystal display, and a digital micromirror device.

10. An optical unit, comprising:
a display panel configured to emit an image light beam;
a projection optical system configured to collimate the image light beam from the display panel; and
a light-guiding member including a light-guiding plate that guides the image light beam, an incidence portion that causes the image light beam to enter the light-guiding plate, a relay portion that guides the image light beam passing through the incidence portion and enlarges a pupil in a first direction, and an emission portion that guides the image light beam passing through the relay portion, enlarges the pupil in a second direction orthogonal to the first direction, and emits the image light beam from the light-guiding plate, wherein
an exit pupil of the projection optical system has a shape in which a vertical width is larger than a lateral width, and
the incidence portion has a shape in which a vertical width is larger than a lateral width, correspondingly to the shape of the exit pupil.
